(19) United States
(12) Patent Application Publication
(10) Pub. No.: US 2008/0079226 A1
(43) Pub. Date: Apr. 3, 2008

(54) Linkages for adjusting axle span and securing pole on log trucks

(76) Inventors: Larry A. Helmer, Pineland, TX (US); James C. Helmer, Pineland, TX (US)

Correspondence Address: John M. Harrison, 2139 E. Bert Kouns, Shreveport, LA, 71105, US

(21) Appl. No.: 11/901,387

(22) Filed: Sep. 17, 2007

Related U.S. Application Data
(60) Provisional application No. 60/848,802, filed on Oct. 2, 2006.

(51) Int. Cl. B62D 21/14

(52) U.S. Cl. 280/35; 280/144; 280/86.5

(57) ABSTRACT

An axle span linkage for adjusting the axle span on a log truck, including front and rear locks pivotally mounted to a bolster pipe receiving the pole of a log truck. The front lock engages a collar mounted on the pole when the rear axle bolster is positioned in a forward orientation on the pole, for orienting the bolster closest to the tractor. The rear lock engages a like collar mounted on the rear end of the pole when the bolster is positioned rearwardly on the pole from the first position. The axle span linkage includes a front adjustable rod attached to the front lock and extending rearwardly for attachment to a pivot arm. A rear adjustable rod extends from the pivot arm to the rear lock. An air cylinder operates the pivot arm to selectively engage the front and rear locks with the respective collars against spring tension. A pole-engaging linkage mounts on the headache rack of the truck rearwardly of the pole-engaging rest. The pole-engaging linkage includes a pair of pole-engaging bars pivotally attached to the headache rack and spaced-apart by a pivoting spacer bar and a spring. The piston of an air cylinder is connected to one of the pole-engaging bars and leg springs extend between the pole-engaging bars and the headache rack. Operation of the air cylinder causes the pole-engaging bars to open at the top to receive the jackknifed pole and reverse operation of the air cylinder closes the pole-engaging bars on the pole, to retain the pole on the rest.

### CROSS-REFERENCE TO RELATED APPLICATIONS

This application claims the benefit of and incorporates by reference prior filed copending Provisional Application Ser. No. 60/848,802, Filed Oct. 2, 2006.

### SUMMARY OF THE INVENTION

This invention relates to a linkage for adjusting the axle span on log trucks and a pole-engaging mechanism or linkage for securing the folded, hinged truck pole in position on the truck headache rack when the rear axle or bolster is loaded on the tractor. The axle span linkage includes a front lock pivotally mounted to a bracket attached to a bolster pipe fixed to the bolster, which slidably receives the pole or central connecting member connecting the tractor to the bolster and a rear lock pivotally attached to a similar bracket also attached to the bolster pipe. The front lock is designed for engagement with a front collar bolted or welded to the pole under circumstances where the bolster is positioned in a forward orientation on the pole, for orienting the bolster closer to the tractor. The rear lock is spring-loaded to engage a similar collar welded or bolted to the rear end of the pole, under circumstances where the bolster and bolster pipe are to be moved in concert rearwardly on the pole from the first position, to accommodate longer logs extending between the tractor and the bolster. The span-adjusting linkage further includes a front adjustable rod attached to the front lock and extending rearwardly for attachment to a pivot arm pivotally attached to the bolster. A rear adjustable rod extends from the pivot arm to the rear lock and an air cylinder operates the pivot arm to selectively engage the front and rear locks against spring tension. Since the bolster pipe is slidably mounted on the pole, the pole can move rearwardly and forwardly in the bolster pipe with respect to the bolster by operating the tractor to facilitate engaging the front or rear locks, as desired, depending upon the length of the logs to be loaded and carried by the truck.

The pole-engaging assembly or linkage typically is mounted on the headache rack of the tractor for receiving the hingedly-collapsed or folded pole when the rear axle or bolster is loaded on the tractor for transport without a load of logs. The pole-engaging linkage is characterized by a pair of spaced-apart pole-engaging bars pivoted at the lower end to the headache rack and provided with a pivoting spacer bar at the lower end thereof and spaced by a spring. An air cylinder has an air cylinder piston attached to the bottom of one of the pole-engaging bars and a pair of bar or leg springs are connected to the bottom ends of the pole-engaging bars and to the headache rack. Operation of the air cylinder to extend the piston from the air cylinder causes the top ends of the pole-engaging bars to spread-apart against spring tension and accommodate the jackknifed or folded pole when the pole is lowered in closed hinge configuration onto the headache rack. Retraction of the air cylinder piston in the air cylinder with the help of the leg or bar springs causes the top flanges of the pole-engaging bars to engage the pole and secure the pole in folded or jackknifed configuration on the pole rest or cradle fitted to the headache rack.

### BRIEF DESCRIPTION OF THE DRAWINGS

The invention will be better understood by reference to the following drawings, wherein:

FIG. 1 is a rear perspective view of a log truck rear axle or bolster with the span-adjusting linkage disposed in a “long log” hauling configuration;

FIG. 2 is a front perspective view of the bolster illustrated in FIG. 1 with the span-adjusting linkage disposed in a “short log” hauling configuration;

FIG. 3 is a perspective view of the bolster pipe and conventional pole, along with the span-adjusting linkage illustrated in the “short log” hauling configuration illustrated in FIG. 2;

FIG. 4 is a perspective view, partially in section, of the bolster pipe, pole and front end of the span-adjusting linkage illustrated in FIG. 3;

FIG. 5 is a perspective view, partially in section, of the bolster pipe, pole and front end of the span-adjusting linkage illustrated in FIG. 3, with the front lock released and the rear lock engaged with the pole as illustrated in FIG. 1;

FIG. 6 is a rear perspective view, partially in section, of the bolster, pole and rear end of the span-adjusting linkage illustrated in FIG. 2;

FIG. 7 is a perspective view, partially in section, of the folded pole-engaging linkage receiving the folded or jackknifed pole;

FIG. 8 is a perspective view, partially in section, of the folded pole-engaging linkage without the jackknifed pole; and

FIG. 9 is a perspective view, partially in section, of the folded pole-engaging linkage in functional configuration ready to receive the jackknifed pole illustrated in FIG. 7.

### DESCRIPTION OF THE PREFERRED EMBODIMENTS

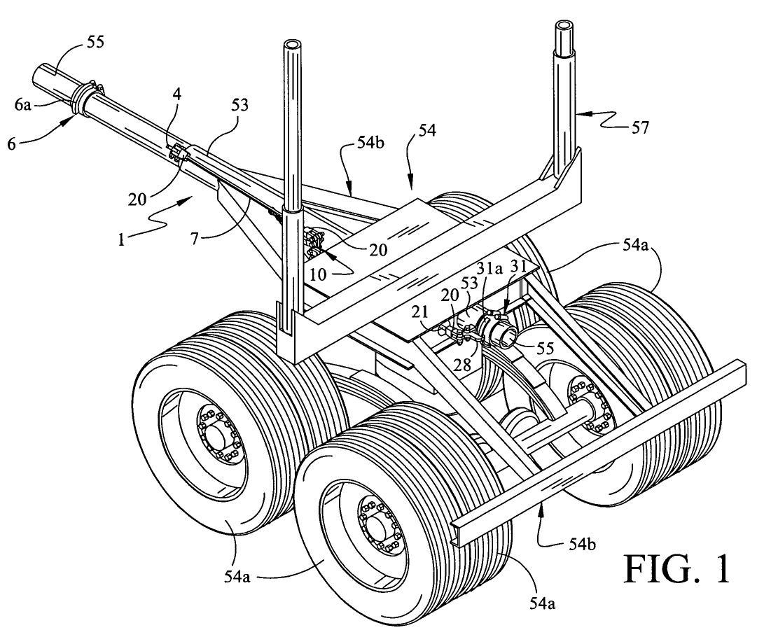

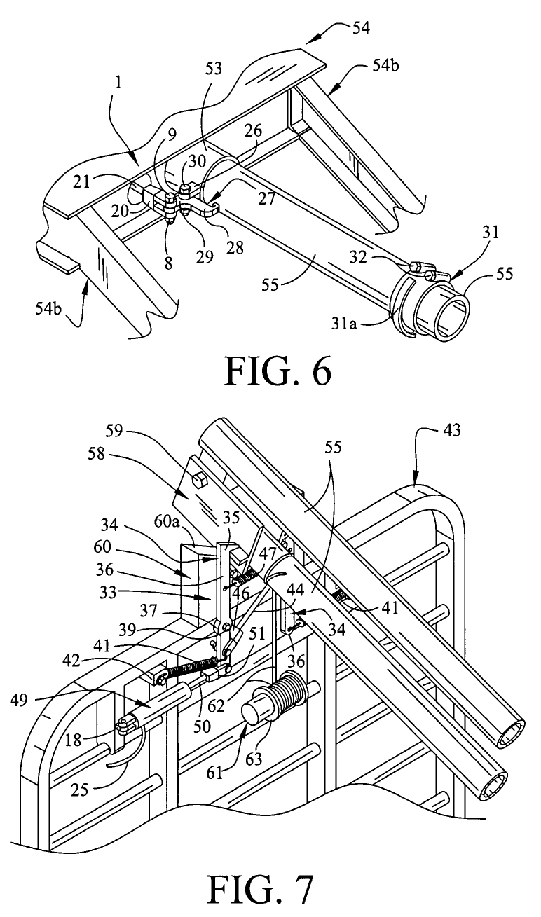

Referring initially to FIGS. 1-7 of the drawings, the rear axle or bolster 54, fitted with bolster tires 54a, is illustrated for attached to a log truck tractor (not illustrated) by means of a conventional pipe or pole 55. The pole 55 is typically articulated or hinged in conventional fashion at a pole hinge 58 and pole hinge bolt 59 (FIG. 7) to facilitate loading of the bolster 54 on the tractor of the log truck (not illustrated) when the log truck is not in use for hauling logs.

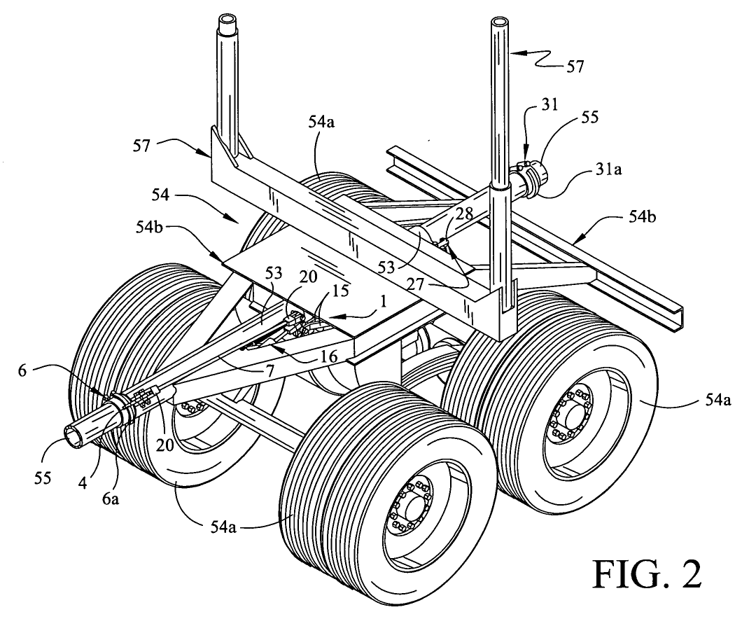

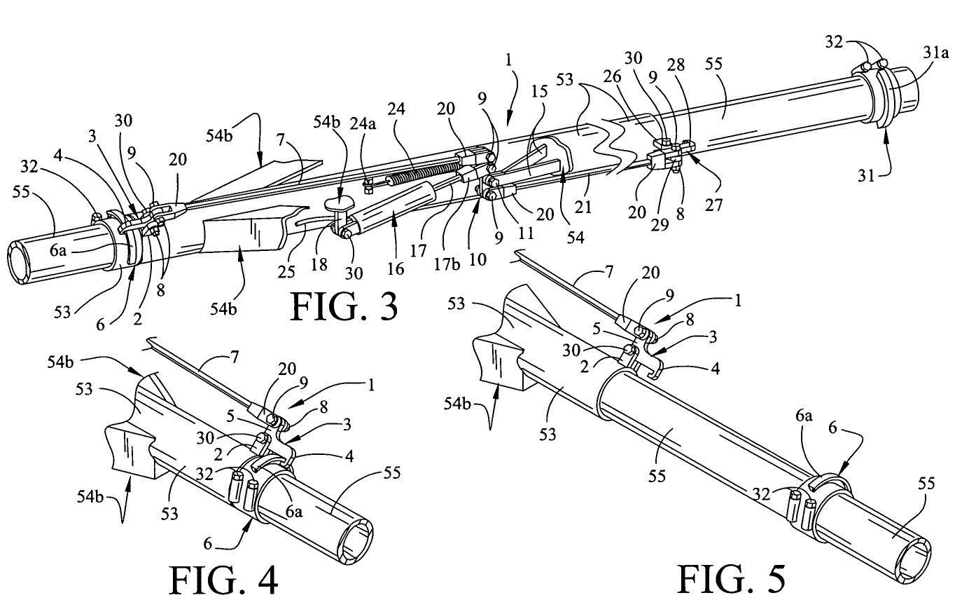

Referring now to FIGS. 1-6 of the drawings, the span-adjusting linkage of this invention is generally illustrated by reference numeral 1. The span-adjusting linkage 1 is mounted on a bolster pipe 53, fixed to the bolster frame 54b of the bolster 54 and is designed to facilitate multiple positions of the bolster 54 on the pole 55, which slidably extends through the bolster pipe 53, depending upon the length of the logs to be carried by the log truck on the bolster log rack 57. As illustrated in FIGS. 3-5, the span-adjusting linkage 1 is characterized by a front lock plate bracket 2, which is typically welded to the bolster pipe 53 forwardly of the bolster 54 and pivotally receives a shaped front lock plate 3, fitted with a front lock plate hook 4 at one end and a front lock plate arm 5 at the other end. The front lock plate 3 is typically pivotally attached to the front lock plate bracket 2 by a bracket bolt 30 and a nut 8 and an opening (not illustrated) provided in the front lock plate arm 5 receives a clevis bolt 9, secured by a nut 8, for attaching a rod clevis 20 to the front lock plate arm 5 in pivoting relationship. The rod clevis 20 receives one end of a front rod 7, which may be threadably adjustable as to length in the rod clevis 20, and extends rearwardly to a second rod clevis 20, as illustrated in FIG. 3. The second or rearward rod clevis 20 is attached to the top end of a pivot arm 10, as further illustrated in FIG. 3, using a clevis bolt 9 and a nut 8. The linkage air cylinder piston 17 of a linkage air cylinder 16 is likewise attached to the pivot arm 10 beneath the front rod 7, typically by means of a piston clevis 17b and a clevis bolt 9 is typically used to secure the linkage air cylinder piston 17 to the pivot arm 10 at the piston clevis 17b. The linkage air cylinder 16 is typically attached to the bolster frame 54b of the bolster 54 by an air cylinder bracket 18. An air hose 25 extends from the linkage air cylinder 16 to a source of compressed air (not illustrated) and a solenoid (not illustrated) is electrically connected to the linkage air cylinder 16 and to a toggle switch (not illustrated) located in the tractor of the log truck, to selectively energize the linkage air cylinder 16 responsive to manipulation of the cab toggle switch, as hereinafter further described. The pivot arm 10 is pivotally attached to a pivot arm mount 15, also welded or otherwise fixed to the bolster 54, to facilitate pivoting of the pivot arm 10 about a pivot arm bolt 11, which secures the pivot arm 10 to the pivot arm mount 15. One end of a rear rod 21 is pivotally attached to the lower end of the pivot arm 10, typically by means of a rod clevis 20, fitted with a clevis bolt 9 and a nut 8, and the rear rod 21 is typically threaded in the rod clevis 20 for adjustment as to length. The opposite end of the rear rod 21 is also fitted with a rod clevis 20 and is secured by means of another clevis bolt 9 and nut 8 to the rear lock plate arm 29 of a rear lock plate 27. The rear lock plate arm 29 and rear lock plate 27 are pivotally attached to a rear lock plate bracket 26 by a bracket bolt 30 (FIG. 3). The rear lock plate 27 is fitted with a rear lock plate hook 28, which selectively engages the rear collar bracket 31a of a rear collar 31, mounted on the pole 55, typically using collar bolts 32. In similar manner, a front collar 6 is bolted, typically by collar bolts 32, or welded to the pole 55 forwardly of the bolster 54 and includes a front collar bracket 6a, for selectively engaging the front lock plate hook 4 of the front lock plate 3 when the bolster 54 and bolster pipe 53 are positioned forwardly on the pole 55, for carrying shorter logs (FIGS. 2-4), as hereinafter further described. Likewise, the rear lock plate hook 28 of the rear lock plate 27 is designed to engage the rear collar bracket 31a of the rear collar 31 (FIG. 1), under circumstances where the bolster 54 and bolster pipe 53 are positioned rearwardly on the pole 55 adjacent to the rear collar 31, for accommodating larger logs extending between the tractor and the bolster 54, as hereinafter further described. A linkage spring 24 is disposed along the bolster pipe 53 (FIG. 3), with one end secured to a spring mount 24a, provided on the bolster pipe 53, and the other to the pivot arm 10, typically using a mount bolt (not illustrated).

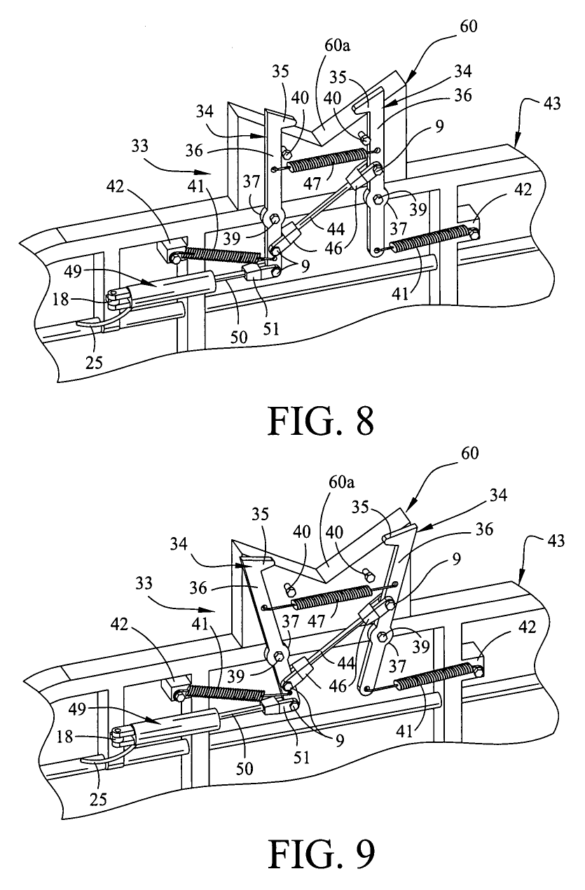

Referring now to FIGS. 7-9 of the drawings, the invention further includes a folded pole-engaging linkage 33 which includes a pair of spaced-apart, upward-standing pole-engaging bars 34, each defining a bar leg 36, and having an inwardly-extending, facing bar flange 35 at the top thereof. Each bar leg 36 is pivotally attached to the headache rack 43 of the log truck tractor at a pivot pin enlargement 37, typically using a pivot pin 39. A pole rest 60, having a V-shaped cradle 60a, is mounted on the headache rack 43 for receiving the articulated pole 55 (FIG. 7). The bar legs 36 extend downwardly from the respective pivot pins 39 and the leg air cylinder piston 50 of a leg air cylinder 49 is attached to one of the bar legs 36, typically by means of a piston clevis 51 and a clevis pin 9 and nut 8. A pair of leg springs 41 are attached to the bar legs 36, respectively, and to the headache rack 43 at leg spring mounts 42, located on the headache rack 43 at the lower ends of the bar legs 36, as further illustrated in FIGS. 7-9. A spacer spring 47 extends between the upper ends of the bar legs 36 and is typically attached to leg openings provided in the bar legs 36 and a spacer bar 44 extends in an angular relationship between the bar legs 36, where it is typically secured by a pair of spacer bar clevis 46, using clevis bolts 9 and nuts 8, respectively. The spacer bar 44 is pivotally attached to the bar legs 36 to facilitate stability in opening and closing of the bar legs 36 responsive to operation of the leg air cylinder 49 against the tension in the spacer spring 47, to accommodate the pole 55 when the pole 55 is in the hinged or folded configuration illustrated in FIG. 7, as hereinafter further described. A pair of stop bolts 40 are seated in the pole rest 60 in spaced-apart relationship to engage and position the bar legs 36 in the closed position illustrated in FIG. 8.

Referring again to FIGS. 1-6 of the drawings, in a preferred embodiment of the invention the span adjusting linkage 1 operates to facilitate placement of short logs (not illustrated) on the tractor and bolster log rack 57 of a log truck where the span-adjusting linkage 1 is configured as illustrated in FIG. 2, as follows. When the bolster pipe 53 is in the “long log” configuration illustrated in FIG. 1, a toggle switch (not illustrated) in the tractor of the log truck is initially manipulated to the open configuration to facilitate operation of the linkage air cylinder 16. This action causes the linkage air cylinder piston 17 to extend, thus pivoting the pivot arm 10 on the pivot arm bolt 11, pulling the bottom end of the pivot arm 10 and the rear rod 21 forwardly and disengaging the rear lock plate hook 28 of the rear lock plate 27 from the corresponding rear collar bracket 31a on the rear collar 31. The extension action of the linkage air cylinder piston 17 also causes the top end of the pivot arm 10 to move rearwardly, against the tension in the linkage spring 24, thus also moving the front rod 7 rearwardly and opening the front lock plate hook 4 on the front lock plate 3 (FIG. 5). The tractor is then backed up, such that the pole 55 slides rearwardly in the bolster pipe 53 of the immobile bolster 54 and the front lock plate 3 approaches the front collar bracket 6a of the front collar 6 (FIG. 5). As the tractor continues to move rearwardly and the bolster 54 remains immobile, the front lock plate hook 4 of the front lock plate 3 engages the front collar bracket 6a under tension in the linkage spring 24, as illustrated in FIGS. 2-4 after the toggle switch is again manipulated to retract the linkage air cylinder piston 17. The log truck is now in a “short log” configuration to load shorter logs, since the bolster 54 is located in a relatively close position with respect to the tractor.

Under circumstances where it is desired to again position the log truck in “long log” configuration from the “short log” set-up and load longer logs on the log truck, the linkage air cylinder 16 is again caused to extend by manipulation of the toggle switch located in the tractor to effect pivoting of the pivot arm 10. This action causes the front rod 7 to move forwardly, with a like forward rotation of the top portion of the pivot arm 10, which releases the front lock plate 4 of the front lock plate 3 from the front collar bracket 6a and correspondingly pivots the rear lock plate 27 outwardly of the pole 55, as illustrated in FIG. 2. The tractor and the pole 55 of the log truck 52 are then advanced with respect to the still immobile bolster pipe 53 and bolster 54, until the rear lock plate hook 28 of the rear lock plate 27 contacts the rear collar bracket 31a of the rear collar 31 and engages the rear collar bracket 31a, responsive to manipulation of the toggle switch to retract the linkage air cylinder piston 17 and operation of tension in the linkage springs 24 (FIG. 1). The bolster 54 is now locked into a “long log” position on the pole 55, such that longer logs (not illustrated) can be loaded on the tractor and the bolster log rack 57 of the bolster 54 in conventional fashion. Accordingly, it will be appreciated by those skilled in the art that the log truck can be maneuvered to locate the pole 55 in both positions in the bolster pipe 53 of the bolster 54 to accommodate logs 57 of desired length, without the driver having to exit the cab of the tractor.

Referring now to FIGS. 7-9 of the drawings, under circumstances where it is desired to load the bolster 54 onto the tractor of the log truck, the span-adjusting linkage 1 is adjusted to lock the rear lock plate hook 28 of the rear lock plate 27 in position against the rear collar bracket 31a of the rear collar 31, such that the bolster 54 is in the position illustrated in FIG. 1, as described above. The conventionally hinged pole 55 is then jackknifed in conventional fashion on the pole hinge bolt 59 at the pole hinge 58, by backing the tractor to engagement with the bolster 54 and rotating the pole 55 downwardly, using a winch cable 62 and winch 61, to the position illustrated in FIG. 7. As the articulated and jackknifed pole 55 extends downwardly and contacts the V-shaped cradle 60a in the pole rest 60 mounted on the headache rack 43, it also extends between the two upward-standing bar legs 36 of the pole-engaging bars 34 in the folded pole-engaging linkage 33, at the bar flanges 35. In a preferred embodiment of the invention the bar legs 36 are spread outwardly at the top from the configuration illustrated in FIG. 8, to the configuration illustrated in FIG. 9, to extend the bar flanges 35 away from each other against the tension in the spacer spring 47, by operation of a second toggle switch and solenoid valve (not illustrated) and the associated leg air cylinder 49. This open position of the bar legs 36 accommodates the jackknifed pole 55 until the pole 55 is resting on the cradle 60a of the pole rest 60, as further illustrated in FIG. 7. The leg cylinder piston 50 can then be retracted in the leg air cylinder 49 by manipulation of the toggle switch to close the bar flanges 35 against the pole 55 and thereby lock the pole 55 into the position illustrated in FIG. 7.

It will be appreciated by those skilled in the art that the span-adjusting linkage 1 and folded pole-engaging linkage 33 of this invention together facilitate more secure positioning of the bolster pipe 53 and bolster 54 on the pole 55 to accommodate logs of varying length, as well as securing of the articulated or jackknifed pole 55 in position on the pole rest 60, when the bolster 54 is loaded on the log truck tractor. Moreover, these adjustments can be facilitated without the driver having to leave the cab, as the folded pole-engaging linkage 33 is typically activated by the second toggle switch (not illustrated) provided in the cab of the log truck tractor, in the same manner as the span-adjusting linkage 1 and the second solenoid (not illustrated) can be utilized to activate the air cylinder 49 as described above with respect to the leg air cylinder 49.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A span-adjusting linkage for adjusting the span between a tractor and a bolster along the pole of a log truck, comprising a first lock pivotally carried by the bolster for selectively engaging the pole when the bolster is in a first selected span with respect to the tractor; a second lock pivotally carried by the bolster for selectively engaging the pole when the bolster is in a second selected span with respect to the tractor; and a linkage apparatus carried by the bolster and connected to said first lock and said second lock, wherein said first lock and said second lock selectively engage and disengage the pole in said first selected span and said second selected span, respectively, responsive to movement of the tractor and the pole with respect to the bolster and operation of said linkage apparatus.

2. The span-adjusting linkage of claim 1 wherein said linkage apparatus comprises a first rod attached to said first lock; a second rod attached to said second lock; a pivot arm pivotally carried by said bolster, with said first rod and said second rod connected to said pivot arm; a fluid-actuated cylinder carried by said bolster; and a piston extending from said fluid-actuated cylinder to said pivot arm, wherein operation of said fluid-activated cylinder and said piston causes said operation of said linkage apparatus and said first lock and said second lock selectively disengage the pole.

3. The span-adjusting linkage of claim 2 comprising at least one spring connected to said pivot arm and the bolster for normally biasing said pivot arm wherein said first lock and said second lock normally engage the pole.

4. The span-adjusting linkage of claim 2 wherein said fluid-actuated cylinder comprises an air-actuated cylinder.

5. The span-adjusting linkage of claim 2 wherein said fluid-actuated cylinder comprises an air-actuated cylinder and comprising at least one spring connected to said pivot arm and the bolster for normally biasing said pivot arm wherein said first lock and said second lock engage the pole.

6. The span-adjusting linkage of claim 1 comprising a first collar provided on the pole forwardly of the bolster for receiving said first lock and a second collar provided on the pole rearwardly of the bolster for receiving said second lock, responsive to said movement of the tractor and operation of said linkage apparatus.

7. The span-adjusting linkage of claim 6 comprising a first rod attached to said first lock;
a second rod attached to said second lock; a pivot arm pivotally carried by said bolster, with said first rod and said second rod connected to said pivot arm; a fluid-actuated cylinder carried by said bolster; and a piston extending from said fluid-actuated cylinder to said pivot arm, wherein operation of said fluid-activated cylinder and said piston causes said operation of said linkage apparatus and said first lock and said second lock disengage said first collar and said second collar, respectively.

8. The span-adjusting linkage of claim 7 comprising at least one spring connected to said pivot arm and the bolster for normally biasing said pivot arm wherein said first lock and said second lock normally engage said first collar and said second collar, respectively.

9. The span-adjusting linkage of claim 1 comprising a bolster pipe fixed to the bolster for slidably receiving the pole and wherein said first lock is pivotally carried by said bolster pipe forwardly of the bolster and said second lock is pivotally carried by said bolster pipe rearwardly of the bolster.

10. The span-adjusting linkage of claim 9 wherein said linkage apparatus comprises a first rod attached to said first lock; a second rod attached to said second lock; a pivot arm pivotally carried by said bolster pipe, with said first rod and said second rod connected to said pivot arm; a fluid-actuated cylinder carried by said bolster; and a piston extending from said fluid-actuated cylinder to said pivot arm, wherein operation of said fluid-activated cylinder and said piston causes said operation of said linkage apparatus and said first lock and said second lock selectively disengage the pole.

11. The span-adjusting linkage of claim 10 comprising at least one spring connected to said pivot arm and the bolster pipe for normally biasing said pivot arm, wherein said first lock and said second lock engages the pole.

12. The span-adjusting linkage of claim 12 wherein said fluid-actuated cylinder comprises an air-actuated cylinder and comprising a first collar provided on the pole forwardly of the bolster for receiving said first lock and a second collar provided on the pole rearwardly of the bolster for receiving said second lock, responsive to said movement of the tractor and operation of said linkage apparatus.

13. A method for remotely locking the pole of a log truck in the bolster pipe of a bolster to selectively accommodate logs of any selected length, comprising the steps of:
(a) providing a linkage on the bolster pipe, said linkage having a first lock for selectively engaging and disengaging the pole forwardly of the bolster; a second lock for selectively engaging and disengaging the pole rearwardly of the bolster; a pivot arm pivotally carried by the bolster; a pair of rods connecting said first lock and said second lock to said pivot arm; and a fluid-actuated cylinder connected to said pivot arm; and
(b) providing an electric switch and solenoid for operating said fluid-actuated cylinder and said linkage.

14. The method according to claim 13 comprising the step of providing at least one spring connecting said pivot arm to the bolster for normally biasing said first lock and said second lock in the closed configuration.

15. The method according to claim 13 comprising the step of providing a first collar on the pole forwardly of the bolster for receiving said first lock and a second collar provided on the pole rearwardly of the bolster for receiving said second lock.

16. The method according to claim 13 comprising the steps of:
(a) providing at least one spring connecting said pivot arm to the bolster pipe for normally biasing said first lock and said second lock in the closed configuration; and
(b) providing a first collar on the pole forwardly of the bolster for receiving said first lock and a second collar on the pole rearwardly of the bolster for receiving said second lock.

17. A span-adjusting linkage for adjusting the distance between the tractor and bolster along the pole of a log truck, comprising a first lock pivotally provided on the front end of the bolster; a second lock pivotally provided on the rear end of the bolster; a first collar provided on the pole forwardly of the bolster for receiving said first lock when the tractor and the bolster are in a first selected span with respect to each other; a second collar provided on the pole rearwardly of the bolster for receiving said second lock when the tractor and the bolster are in a second selected span with respect to each other; a pivot arm pivotally carried by the bolster; a first rod having one end attached to said first lock and the opposite end of said first rod connected to said pivot arm; a second rod having one end attached to said second lock and the opposite end of said second rod attached to said pivot arm in spaced-apart relationship with respect to said opposite end of said first rod; at least one spring having one end connected to the bolster and the opposite end of said spring connected to said pivot arm for normally biasing said first lock and said second lock in the closed configuration; and a fluid-actuated cylinder connected to the bolster, with the piston of said fluid-actuated cylinder connected to said pivot arm, wherein said first lock and said second lock are caused to open responsive to operation of said fluid-actuated cylinder and said first collar and said second collar selectively engage said first lock and said second lock, respectively, responsive to movement of the tractor and pole of the log truck with respect to the bolster for said adjusting the distance between the tractor and bolster.

18. A folded pole-engaging linkage for receiving and locking the pole of a log truck on the pole rest of a log truck tractor, comprising a pair of spaced-apart bars pivotally carried by the tractor; a bar spring spacing said bars for normally biasing said bars toward each other; and a fluid-actuated cylinder mounted on the truck tractor and having a piston connected to one of said bars, wherein said bars are caused to pivot against the tension of said bar spring into an open configuration as the pole is rested between said bars on the pole rest and said bars are caused to pivot against the pole into a closed configuration, responsive to operation of said fluid-actuated cylinder and said bar spring.

19. The folded pole-engaging linkage of claim 18 comprising a spacer bar pivotally connected to said bars for stabilizing said bars responsive to said operation of said fluid-actuated cylinder.

20. The folded pole-engaging linkage of claim 18 comprising a pair of leg springs connected to said bars for normally biasing said bars in substantially parallel relationship with respect to each other.

21. The folded pole-engaging linkage of claim 18 comprising:
(a) a spacer bar pivotally connected to said bars for stabilizing said bars responsive to said operation of said fluid-actuated cylinder; and
(b) a pair of leg springs connected to said bars for normally biasing said bars in substantially parallel relationship with respect to each other.

22. The folded pole-engaging linkage of claim 18 comprising a bar flange provided on each of said bars in facing relationship with respect to each other for engaging the pole responsive to said operation of said fluid-actuated cylinder into said closed configuration.

23. The folded pole-engaging linkage of claim 18 comprising:
(a) a spacer bar pivotally connected to said bars for stabilizing said bars responsive to said operation of said fluid-actuated cylinder;
(b) a pair of leg springs connected to said bars for normally biasing said bars in substantially parallel relationship with respect to each other; and
(c) a bar flange provided on each of said bars in facing relationship with respect to each other for engaging the pole responsive to said operation of said fluid-actuated cylinder into said closed configuration.
